(19) United States
(12) Patent Application Publication
(10) Pub. No.: US 2008/0035123 A1
(43) Pub. Date: Feb. 14, 2008

(54) Hydro-energy carboration and combustion system yielding power and no hydrocarbon emissions

(76) Inventor: William F. Rosskob, Lancaster, PA (US)

Correspondence Address: WILLIAM F. ROSSKOB, 1202 GROFFTOWN RD., LANCASTER, PA, 17602, US

(21) Appl. No.: 11/503,004

(22) Filed: Aug. 12, 2006

(51) Int. Cl. F02B 43/00; F02D 9/08; F02N 17/00

(52) U.S. Cl. 123/527; 123/179.7; 123/403

(57) ABSTRACT

A method of carboration and combustion where a combustible gas is mixed and burned in a compression combustion engine yielding power and no hydro carbons. Where a certain H2 gas derivative is mixed with other gases and burned. And where the gas entering the combustion area is controlled by varing the pressure and thus the power output.

### BACKGROUND OF INVENTION

### Field of the Invention

A mechanical electric system as here in described where a form of chemical energy as pure as hydrogen gas can be burned efficiently to yield extreme amounts of safe power with no CO2 by products.

### BRIEF DESCRIPTION OF DRAWINGS

FIG. 1. is an explanatory diagram of the total combustion carboration process where fuel tank 1, contains a high pressure gas of a hydrogen gas derivative approx. 1000 psi or greater that goes to a pressure regulator that decreases the pressure down to medium pressure of approx. 100 psi. This is a basic energy storage system of a gas that when burned, will release no hydrocarbons and power.

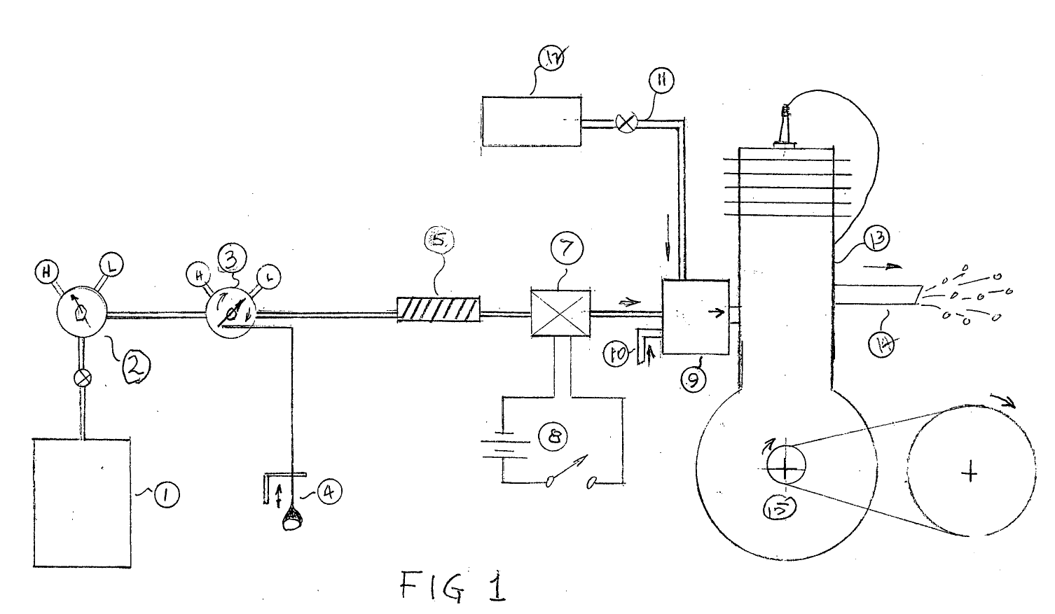

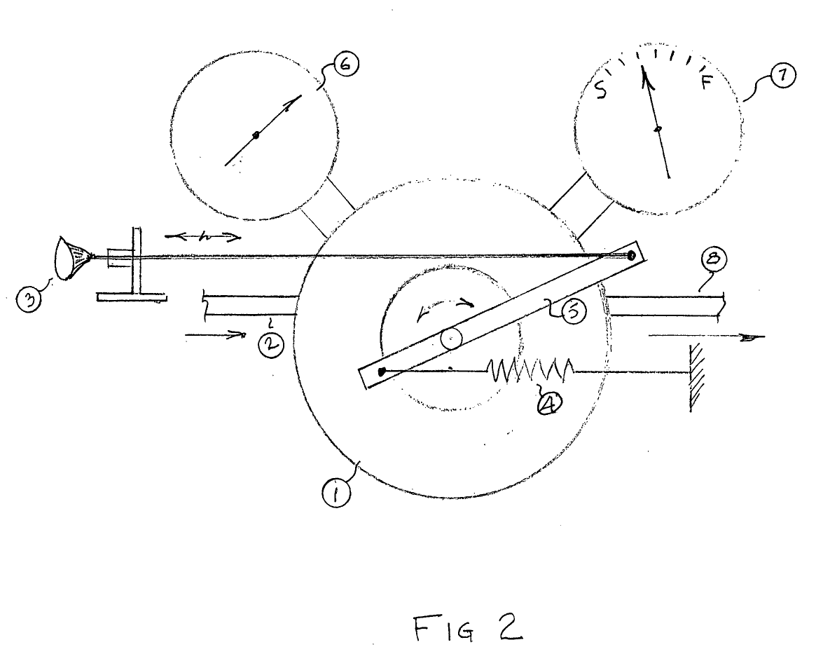

The gas than is piped to regulator 3, that decreases the pressure down to 0 to 20 psi. This regulator also acts as the means of controlling the speed of the motor 13, with throttle 4 as can be seen in FIG. 2. Gas leaves regulator on the low side and goes through a spark arrestor and back flow stopper 5, in case of possible flash backs. The hydrogen gas derivative combustible gas is allowed to enter the carborator 9, by means of which an open/close electrical switch 7, that controls when the motor is turned on or off. It can be manual or electrically controlled 8, that permits gas into the carborator 9, where air is mixed with. A primer tank 12, injects primer fuel in to the mixing chamber with switch 11, valve to help start engine. The mixing chamber 9, combines explosive primer with H2 gas derivative and air to be injected into piston motor 13 that is exploded to drive piston and deliver energy to wheel 15. The result is mechanical power at 15, and H2O out exhaust port 14, yielding no hydrocarbons.

FIG. 2. To vary the speed of the motor, regulator 1, can be adjusted with throttle 3, that is connected to valve arm 5. Medium high pressure gas enters 2, of which meter 6, shows pressure entering at 2. Throttle 3 moves regulator valve arm 5, that increases or decreases pressure leaving regulator at 8, from 0 to 50 psi approx. that enters mixing chamber. Spring 4, returns valve arm to 0 position. Low side pressure gage 7, shows speed. More pressure increases motor speed, less pressure decreases speed. Hence, this device is the power regulator.

What is claimed is:

1. A system that uses a hydrogen energy gas to run a motor that is controlled varing the pressure entering the carborator mixing chamber.

2. A gas flows through a spark arrestor and a controlled valve switch that permits gases to flow into a mixing chamber.

3. An explosive primer gas that helps start engine.

4. A mixing carborator that combines explosive gases with air to be injected to a compression piston motor cylinder when ignited emits power to drive a mechanical wheel and exhaust emission of H2O with no hydrocarbon emissions.
